(19) United States
(12) Patent Application Publication
(10) Pub. No.: US 2026/0077724 A1
(43) Pub. Date: Mar. 19, 2026

(54) THERMAL PROTECTIVE BUSHING

(71) Applicant: FCA US LLC, Auburn Hills, MI (US)

(72) Inventors: Ian R. Williams, Auburn Hills, MI (US); Phillip J. Fershin, Auburn Hills, MI (US)

(21) Appl. No.: 18/886,297

(22) Filed: Sep. 16, 2024

(51) Int. Cl. B60R 13/08

(52) U.S. Cl. CPC B60R 13/0815; B60R 2013/0807

(57) ABSTRACT

A trim part for a vehicle has a body with an attachment bracket to secure the trim part to the vehicle. A thermal bushing is coupled with the attachment bracket to provide thermal insulation for the trim part and the trim attachment bracket. The bushing has a first disk portion, a second disk portion and a cylindrical body, with two ends. The first and second disks are each positioned at one end of the cylinder. A bore passes through the first disk portion, cylindrical body and second disk portion to receive a fastener. A wall defining the bore is sized to define an air gap between the fastener and the bushing.

### FIELD

The present disclosure relates to vehicles and, more particularly, to a thermal protection bushing for trim components.

### BACKGROUND

This section provides background information related to the present disclosure which is not necessarily prior art.

Generally, when a part, preferably a plastic part, comes in contact with a secondary component that potential generates elevated temperate, the part may experience warp, distortion and degradation. To suppress the above, thermal protecting components such as ceramic washers have been utilized. However, these washers are inadequate to accommodate compressive loads. Generally, when a fastener is tightened against the ceramic washers, the ceramic washers fail and generally crumble into pieces. The ceramic washers only protect the face of the component and do not protect the thermal conductivity from the sides of a screw. Thus, it would be desirable to provide a thermal protection barrier that overcomes the deficiencies of the prior art.

Accordingly, the present disclosure provides a solution to overcome the deficiencies of the prior art. The present disclosure provides a thermal protection bushing that limits the conductivity of heat from the heat source. It protects the component behind the thermal protection bushing. The thermal protection bushing also provides an air gap between components to mitigate thermal radiation from the heat source to the surrounding parts. The present disclosure provides a thermal protection bushing that is easily molded into the component it is protecting as well as isolating it from the attachment screw from the heat source.

### SUMMARY

This section provides a general summary of the disclosure, and is not a comprehensive disclosure of its full scope or all of its features.

According to an aspect of the disclosure, a trim part comprises a body that includes an attachment bracket to secure to the trim plate of the vehicle. A thermal bushing is coupled with the attachment bracket to provide thermal insulation for the trim part. The bushing includes a first disk portion, a second disk portion and a cylindrical body connecting the two disk portions together. A through bore extends between the first and second disks as well as the cylindrical body portion to receive a fastener. A wall defining the bore defines an air gap between the fastener and the bushing. The thermal bushing is a one piece construction. The thermal bushing is made from non-ceramic material that provides high heat resistance and low flammability. One such material is DURAFIDE PPS that enables compression on the thermal bushing by the fastener head. The thermal bushing is molded into the attachment bracket of the part. The gap is generally 0.25 mm to 0.5 mm radially between the fastener and the wall.

According to a second aspect of the disclosure, a vehicle including an interior trim part comprises a vehicle cab to receive the trim part. The cab accesses the heat source. The trim part is connected to the heat source. The trim part comprises a body that includes an attachment bracket to secure to the trim plate of the vehicle. A thermal bushing is coupled with the attachment bracket to provide thermal insulation for the trim part. The bushing includes a first disk portion, a second disk portion and a cylindrical body connecting the two disk portions together. A through bore extends between the first and second disks as well as the cylindrical body portion to receive a fastener. A wall defining the bore defines an air gap between the fastener and the bushing. The thermal bushing is a one piece construction. The thermal bushing is made from non-ceramic material that provides high heat resistance and low flammability. One such material is DURAFIDE PPS that enables compression on the thermal bushing by the fastener head. The thermal bushing is molded into the attachment bracket of the part. The gap is generally 0.25 mm to 0.5 mm between the fastener and the wall.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective schematic view of a vehicle with an interior.

FIG. 2 is a cross-section view of FIG. 1 along line 2-2 thereof.

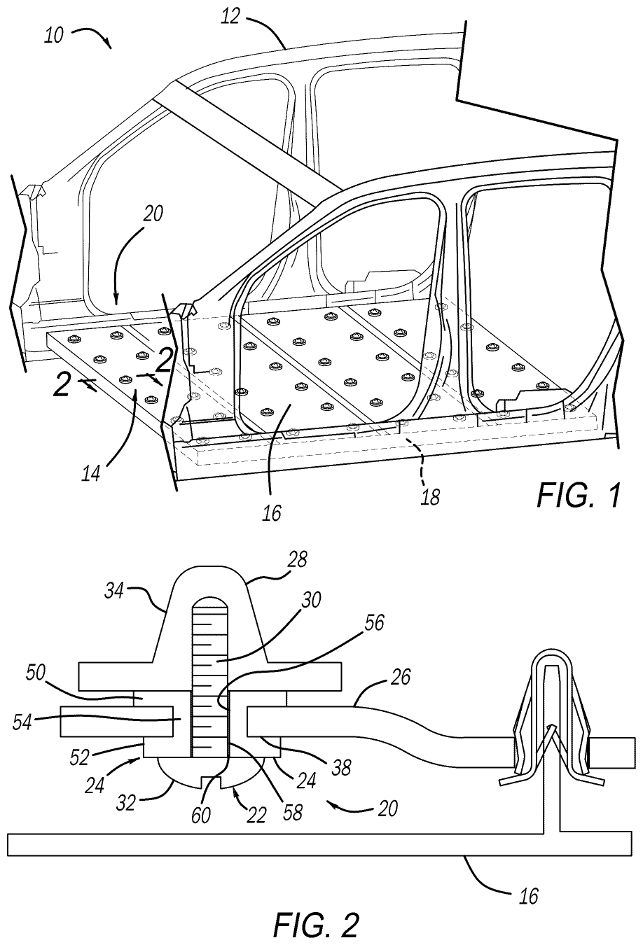

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle 10 includes a cab 12 having an interior 14. The interior 14 includes a trim part 16 illustrated as a floor board. The trim part 16 is positioned above a battery pack 18. The trim portion 16 is secured to the battery via a fastener 20 and 22.

Turning to FIG. 2, a cross-section of the fastener 20, 22 and trim part 16 is illustrated. The fastener, a screw 22, is passed through a thermal bushing 24 that is attached to the trim attachment bracket 26. The screw 22 is secured to the heat source 28 such as the battery. The screw 22 has a shaft 30 and a head 32. Generally, the screw 22 is manufactured from a metallic material and includes male threads 34 that secure it with the heat source 28 that has female threads 34.

The trim attachment bracket 26 includes an aperture 38. The aperture 38 receives the thermal bushing 24 so that it can be press fit, molded or the like to the trim bracket 26. The bushing 24 can be easily molded into the trim attachment bracket so that it protects as well as isolates the attachment screw 22 from the heat source 28.

The thermal protective bushing 24 includes a first disk portion 50 and a second disk portion 52. The disk portions 50, 52 are separated by and unitarily formed with a cylindrical body portion 54. The first 50 and second 52 disk portions and the cylindrical body portion 54 include a bore 56 that passes through the bushing 24. The bore provides an entrance for the screw 22.

The bore wall 58 is sized, oversized, such that a gap 60 is created between the screw 22 and the bushing 24. The gap 60 generally has a size that is 0.25 mm to 0.5 mm between the screw shaft 30 and the bore wall 58.

The bushing 24 is formed from a high heat resistance low flammability plastic material. The material provides for a compressive load to be placed onto the disk portions 50, 52 so that the screw head 32 contacts the disk portion 52 providing compression to maintain the trim part 16 in position. One such material that may be utilized for the bushing 24 is DURAFIDE PPS. Thus, the bushing 24 is easily molded into the plastic trim attachment bracket 26 to prevent the conductivity of heat from the heat source 28 and to protect the component 16.

Generally, the thermal protection bushing air gap 60 between the screw shaft 30 and the bushing 24 mitigates thermal radiation from the heat source 28 to the surrounding parts 26. Thus, the bushing 24 is easily molded or the like into the trim attachment bracket part 26 that it protects as well as isolates the attachment screw 22 from the heat source 28. Accordingly, this generally eliminates warping, distortion and degradation of the trim part 16 and trim attachment bracket 26.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A trim part for a vehicle comprising:
a trim part having a body, the body including an attachment bracket to secure the trim part to the vehicle;
a thermal bushing is coupled with the attachment bracket for providing thermal insulation for the trim part, the bushing including a first disk portion, a second disk portion and a cylindrical body with two ends, the first and second disk are each positioned at one end of the cylinder, a bore passes through the first disk portion, cylindrical body and second disk portion for receiving a fastener, and a wall defining the bore is sized to define an air gap between the fastener and the bushing.

2. The trim part for a vehicle of claim 1, wherein the thermal bushing is a one piece construction.

3. The trim part for a vehicle of claim 1, wherein the thermal bushing is made from non-ceramic material.

4. The trim part for a vehicle of claim 3, wherein the material is DURAFIDE PPS enabling compression of the thermal bushing by the fastener head.

5. The trim part for a vehicle of claim 1, wherein the thermal bushing is molded into the trim attachment bracket.

6. The trim part for a vehicle of claim 1, wherein the gap is about 0.25 mm to 0.5 mm between the fastener and the wall.

7. A vehicle including an interior trim part comprising:
a vehicle cab for receiving the trim part, a heat source adjacent the cab;
the trim part connected to the heat source, the trim part comprising:
a body, the body including an attachment bracket to secure the trim part to the vehicle;
a thermal bushing is coupled with the attachment bracket for providing thermal insulation for the trim part, the bushing including a first disk portion, a second disk portion and a cylindrical body, with two ends, the first and second disk are each positioned at one end of the cylinder, a bore passes through the first disk portion, cylindrical body and second disk portion for receiving a fastener, and a wall defining the bore is sized to define an air gap between the fastener and the bushing.

8. The vehicle of claim 7, wherein the thermal bushing is a one piece construction.

9. The vehicle of claim 7, wherein the thermal bushing is made from non-ceramic material.

10. The vehicle of claim 9, wherein the material is DURAFIDE PPS enabling compression of the thermal bushing by the fastener head.

11. The vehicle of claim 7, wherein the thermal bushing is molded into the trim attachment bracket.

12. The vehicle of claim 7, wherein the gap is between 0.25 mm to 0.5 mm between the fastener and the wall.
